(19) United States
(12) Patent Application Publication
(10) Pub. No.: US 2015/0193861 A1
(43) Pub. Date: Jul. 9, 2015

(54) DIRECT FROM COMMUNICATION BUYING

(71) Applicant: Modest, Inc., Chicago, IL (US)

(72) Inventors: Harper Reed, Chicago, IL (US); Dylan Richard, Chicago, IL (US); Gauri Sharma, Chicago, IL (US)

(21) Appl. No.: 14/592,299

(22) Filed: Jan. 8, 2015

Related U.S. Application Data
(60) Provisional application No. 61/925,091, filed on Jan. 8, 2014.
(60) Provisional application No. 62/091,140, filed on Dec. 12, 2014.

(51) Int. Cl. G06Q 30/06; G06Q 30/04; G06Q 10/08; G06Q 30/02; G06Q 20/40

(52) U.S. Cl. CPC G06Q 30/0635; G06Q 30/0241; G06Q 20/407; G06Q 10/083; G06Q 30/04; G06Q 20/40

(57) ABSTRACT

A system and application for completing an electronic purchase transaction directly from a seller's electronic marketing communication to a user are provided. An electronic marketing communication listing products for sale by the seller is provided on a user's device, including a buy selector associated with each listed product. Upon user selection of the buy selector when viewing the electronic marketing communication, an electronic purchase transaction of the selected product is immediately completed if it is determined that the user is logged in and the user's shipping and billing information are complete. A receipt of the purchase transaction is displayed, where unbuy, edit and continue shopping options are provided with the receipt. User interfaces prompt for completion of login or user information if necessary. Machine-readable medium for direct from communication buying are also provided.

### CROSS-REFERENCE TO RELATED APPLICATIONS

This application claims the benefit of U.S. Provisional Patent Application No. 61/925,091, filed Jan. 8, 2014, and U.S. Provisional Patent Application No. 62/091,140, filed Dec. 12, 2014, all of which are expressly incorporated herein by reference and made a part hereof.

### TECHNICAL FIELD

The present disclosure generally relates to completing a purchase transaction, and, in particular, to completing a purchase transaction directly from an electronic communication.

### BACKGROUND

Online retail purchases or transactions typically require a user to go through multiple steps to purchase a product or service they see in an online marketing communication. For example, a user may receive a marketing email or text/push notification from a retailer highlighting a product or service of interest to the user. However, the user typically has to click on a link to go to the retailer's website to buy the product, or copy and paste a retailer's uniform record locator (URL) into a search engine. In some cases, by clicking on a link in the electronic marketing communication, the user may add the highlighted product to a shopping cart at the online retailer's website or be directed to a product page to learn more about the product.

In addition, typical online shopping processes require the user to add products to an online shopping cart and then proceed through a checkout process much like one does in a physical store. However, often a user will abandon the shopping cart for a variety of reasons (e.g., internet connection lost, have to do something else, etc.), but later may wish to complete the purchase of the items in the shopping cart. To complete the order in this case, the user typically has to return to the retailer's website and start the checkout process from the beginning.

Accordingly, it is desirable to provide a system for users to complete an online purchase directly from an electronic marketing communication without having to go to a web page or an application.

### SUMMARY

According to one embodiment, the disclosed subject technology relates to a system for providing direct from communication buying. The system includes one or more processors, one or more storage memories, a display and a direct from communication buying module comprising instructions for causing the one or more processors to execute a method for providing a purchase directly from an electronic communication. The method includes receiving, by a user, an electronic marketing communication from a seller. The method also includes providing, on the display, the electronic marketing communication comprising a listing of one or more products offered for purchase from the seller and a buy selector associated with at least one of the listed products. The method further includes determining, by the one or more processors, if the user is logged in to the direct from communication buying system, if user shipping address information is complete, and if user billing information is complete. The method also includes providing, by the one or more processors, for completing an immediate electronic purchase transaction of the at least one of the listed products when the associated buy selector is selected, if it is determined that the user is logged in, the user shipping address information is complete and the user billing information is complete.

The disclosed technology further relates to a non-transitory machine-readable storage medium comprising machine readable instructions for causing a processor to execute a method for providing a purchase directly from an electronic communication. The method includes providing, on the display, an electronic marketing communication comprising a listing of one or more products offered for purchase from the seller, a purchase price for each of the one or more listed products, and a buy selector associated with each of the one or more listed products. The method also includes determining, by the one or more processors, if the user is logged in to the direct from communication buying system and if user shipping and billing information is complete. The method further includes providing, by the one or more processors, for immediately completing an electronic purchase transaction of one of the one or more listed products when the associated buy selector is selected, if it is determined that the user is logged in and the user shipping and billing information is complete.

The disclosed technology further relates to a direct from communication buying system. The system includes one or more processors, one or more storage memories, a display and a direct from communication buying module comprising instructions for causing the one or more processors to execute a method for providing a completed purchase transaction from an electronic marketing communication. The method includes providing, on the display, an electronic marketing communication from a seller comprising a listing of product information for a product offered for sale by the seller and a buy selector associated with the product. The method also includes determining, by the one or more processors, if the user is logged in to the direct from communication buying system and if user information is complete. If it is determined that the user is logged in and the user information is complete, the method further includes providing, by the one or more processors, for immediately completing an electronic purchase transaction of the listed product when the associated buy selector is selected without requiring further user interaction or a shopping cart checkout process and providing, on the display, a receipt showing details of the completed electronic purchase transaction.

### BRIEF DESCRIPTION OF THE DRAWINGS

To understand the present disclosure, it will now be described by way of example, with reference to the accompanying drawings in which embodiments of the disclosures are illustrated and, together with the descriptions below, serve to explain the principles of the disclosure. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

FIG. 1 is a system diagram of an e-commerce system constructed in accordance with this disclosure.

FIG. 2a is a table illustrating a database record corresponding to a shop.

FIG. 2b is a table illustrating a database record for a catalog item.

FIG. 3 is a flowchart illustrating a process by which a new shopper's information can be gathered.

FIG. 4 is a flowchart illustrating a process by which an order can be placed using the disclosed e-commerce system.

FIG. 5a is a flowchart illustrating a process by which an order can be modified by a shopper.

FIG. 5b is a flowchart illustrating a process by which a return can be processed.

FIG. 6 is a flowchart illustrating a process by which an order can be fulfilled.

FIG. 7 is a flowchart illustrating a process by which items from one shop can be presented to appropriate shoppers of a non-competitive shop.

FIG. 8 is a flowchart illustrating a process by which items can be automatically reordered.

FIG. 9 is a flowchart illustrating a process by which reorders can be generated by the disclosed e-commerce system.

FIG. 10a is a perspective view of a tote bag constructed in accordance with the disclosed e-commerce system.

FIG. 10b is a simplified schematic diagram of a circuit embedded within the tote bag of FIG. 10a to automatically make retail purchases.

FIG. 11a is a side view of a shopping cart constructed in accordance with the disclosed e-commerce system.

FIG. 11b is a simplified schematic diagram of a circuit embedded within the shopping cart of FIG. 11a to automatically make retail purchases.

FIG. 12 is a display illustrating a view that a shopper can receive on first starting a smart phone shopping application.

FIG. 13 is a display illustrating a view that a shopper can receive while entering a search term.

FIG. 14 illustrates an example feature of a direct from communication buying system.

FIG. 15 illustrates another example feature of a direct from communication buying system.

FIG. 16 illustrates another example feature of a direct from communication buying system.

FIG. 17 illustrates another example feature of a direct from communication buying system.

FIG. 18 illustrates another example feature of a direct from communication buying system.

FIG. 19 illustrates another example feature of a direct from communication buying system.

FIG. 20 illustrates an example flow of a direct from communication buying system.

FIG. 21 is a block diagram illustrating an example client and server using the direct from communication buying system of FIGS. 14-19.

FIG. 22 is a block diagram illustrating an example direct from communication buying application in a system.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. Thus, in the following detailed description, numerous specific details are set forth to provide a full understanding of the subject technology. It will be apparent, however, that different aspects of the subject technology may be practiced without some of these specific details. In other instances, well-known structures and techniques have not been shown in detail so as not to obscure the disclosure.

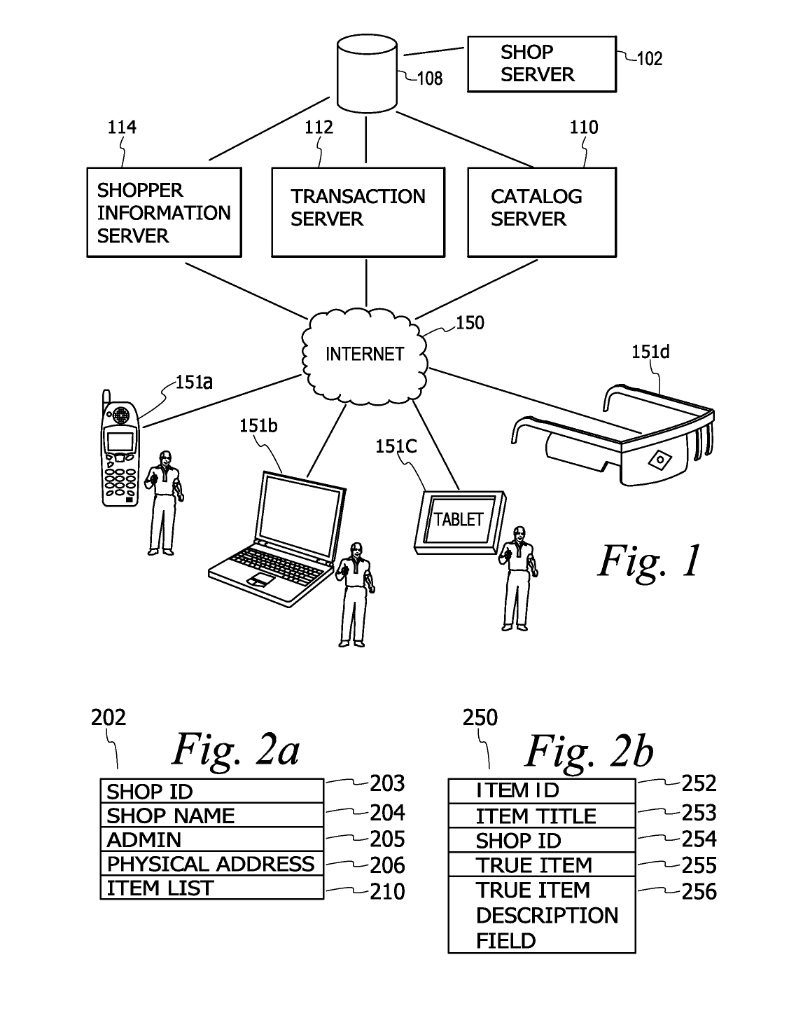

Turning to the Figures and to FIG. 1 in particular, a new e-commerce system is disclosed. A shop server 102 accepts catalog information corresponding to a plurality of shops. For example, the shop server 102 may accept catalogs from a variety of retailers, such as, for example, a sunglass shop, a ladies business clothing store, a high fashion shop, a low price fashion shop, a denim clothing shop, an outdoor clothing store, a footwear store, a plus sized ladies clothing shop, an Asian gift store, a confectionary, a bath store, a home goods store, a jewelry store, an adult toy store, an electronics store, a cell phone store, a music store, an audio-visual store, a children's clothing store, a children's toy store, a lingerie shop, and other types of shop. The shop server 102 creates a structured set of electronic catalogs corresponding to the different shops, and stores those catalogs in the database 108.

A shopper information server 114 gathers information regarding shoppers 151, and creates records in the database 108 corresponding to each shopper. The process by which information is gathered from shoppers is explored in more detail later in this disclosure.

In one embodiment, a catalog server 110 presents catalogs of items from the database 108 to shoppers 151. Similarly, a transaction server 112 allows shoppers 151 to place orders with shops and send messages to shop administrators to fulfill those orders.

It should be noted that shoppers 151 can use a variety of means to transact with the disclosed e-commerce system. For example, shopper 151a utilizes a smart phone, while shopper 151b utilizes a standard computer and shopper 151c utilizes a tablet computer. Finally, shopper 151d utilizes a wearable computer system. The type of computer system used to transact with the disclosed e-commerce system is not a limitation of the invention.

In one embodiment, each electronic catalog comprises a plurality of database records. FIG. 2a depicts a shop record 202 constructed in accordance with this example. It comprises a shop identifier 203, which is unique to shops and used to quickly reference the shop record 202 from another database record. It also comprises a shop name 204, an administrator identifier 205, and a physical address 206. The administrator identifier 205 identifies an administrator record (not depicted) that is used to store access and contact information for one or more shop administrators. In addition, the shop record 202 comprises an item list 210 that references catalog items, as described below.

FIG. 2b depicts a catalog item record 250 constructed in accordance with this example. The catalog item record 250 comprises an item identifier 252, which is unique to items in the database 108 and is used to quickly reference the catalog item record 252 from other records in the database. The catalog item record 250 further comprises an item title 253, a shop identifier (corresponding to the shop which the item belongs to), a true item identifier 255, and a list of true item description fields 256.

A true item identifier 255 corresponds to a generic item type. For example, a true item identifier 255 can identify a set of men's running shoes, a pair of sun glasses, or an audio player. The list of true item description fields 256 comprises a collection of fields that vary based on the generic item type. For example, for a set of men's running shoes, the true item description fields 256 could comprise: a) the primary color; b) the secondary color; c) the shoe size; and d) the type of running shoe (i.e., road, trail, etc.). Other item types would have other item description fields.

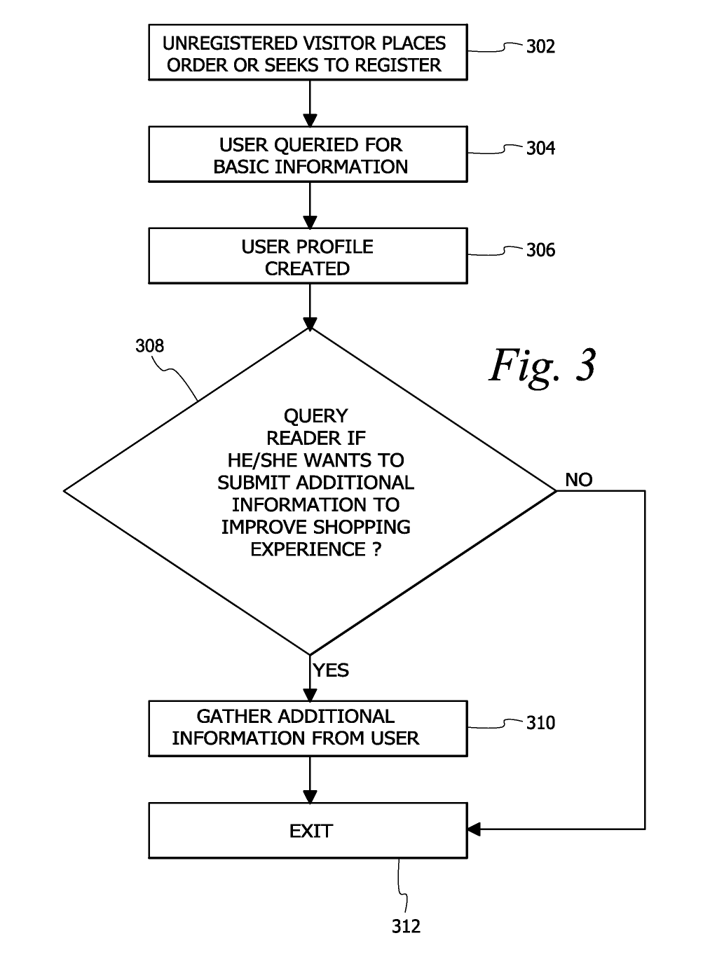

Turning to FIG. 3, a flowchart describing one process by which information from a shopper can be gathered is described. In step 302, an unregistered visitor either seeks to register or attempts to place an order, thereby initiating the information gathering process. In step 304, the user is queried for basic information; i.e.; the user's name, address, email address, mobile phone number, communications preferences, billing information, and billing preferences. With regards to communications preferences, a user can select, for example, to receive order confirmations by email, text message, or robo-call. With regards to billing preferences, a user can select to charge one credit card for certain types of expenses, such as clothing, and another credit card for other expenses, such as office supplies. Other payment forms, such as an online wallet, bit coin address, or gift card can also be entered. Moreover, the user can setup rules that allow for “lowest cost routing” of payment. For example, assuming that a user has three credit cards—one that provides better rates for transactions in excess of $100, one that provides better rates for purchases of electronics goods, and one that is designated as purchases made on behalf of the customer's employer.

In one embodiment, a profile for the user is created in step 306. In step 308, the shopper is queried regarding as to whether s/he wants to submit additional information to improve her shopping experience. If the user prefers to not submit additional information, execution transitions to step 312, where the process is exited. However, if the user agrees to submit additional information, it is gathered in step 310 using any of the profile building techniques well known in the art.

One method by which additional information about a customer's information and preferences can be gathered is through a user's mobile device. Mobile devices, such as smartphones, tend to be used by a single person, and accordingly, tend to have reliable information about that person and that person's preferences. Accordingly, in one embodiment of the disclosed e-commerce system, an application running on a mobile device can gather information regarding the customer, such as the customer's address, phone number, and potentially payment means, such as credit cards, online wallets, etc. Further information regarding a customer's preferences can be gathered through interfaces to other applications, as well as through interfaces through social networks and other online identity sources. For example, from a user's social network, a customer's music and movie likes and dislikes can be extracted, as well as, in many cases, the brands that a user likes. From these preferences, similar brands and preferences can be extrapolated and presented to the user.

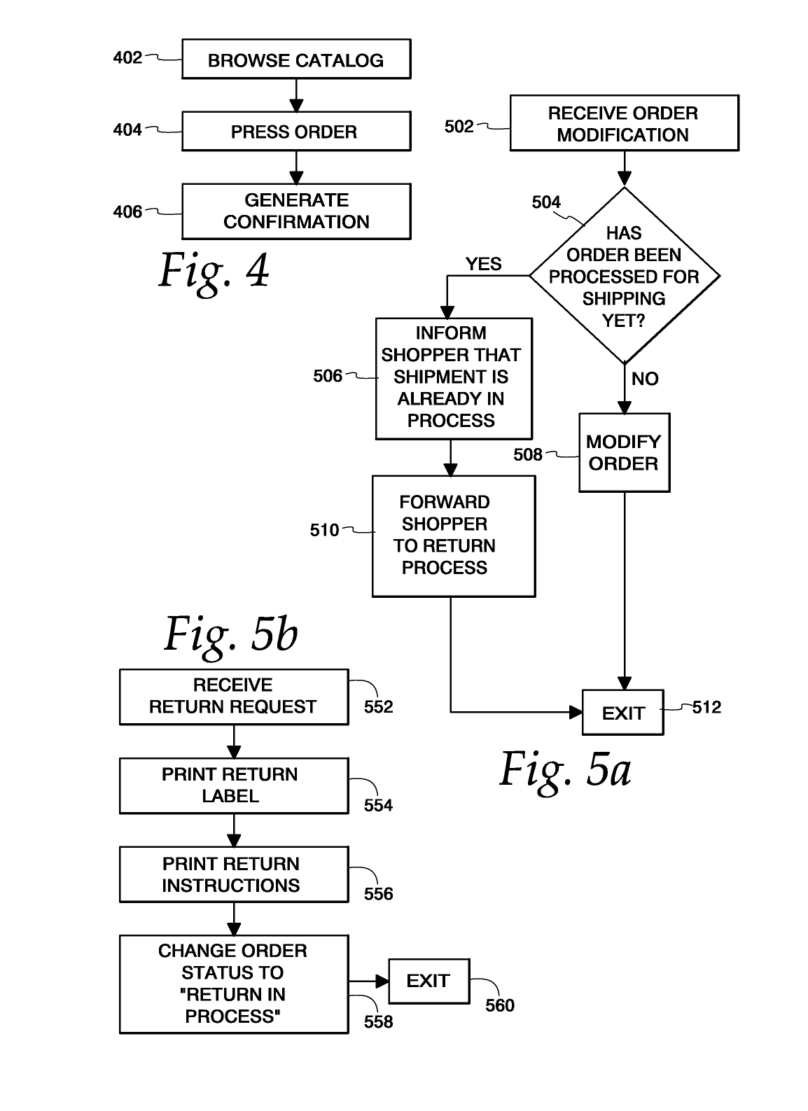

FIG. 4 is a flowchart illustrating one process by which an order can be placed by a shopper. The disclosed multi-tenant e-commerce service does not use a “shopping cart.” Instead, a shopper simply selects “buy” or an equivalent device, which immediately places the order. A confirmation is sent to the user by the user's preferred communication means, allowing the user to modify or cancel the order.

In one embodiment, in step 402, a shopper browses a catalog, or catalogs, until she/he finds a desired item. The shopper then presses “order” or an equivalent device in step 404. A confirmation is sent to the user by the user's preferred communications means in step 406.

In addition, the disclosed e-commerce system supports group ordering. For example, as opposed to pressing “order,” a customer could make an entry that initiates a group order, such as by pressing an “initiate group order” button. The customer could then be presented with a screen that allows the customer to input a list of contacts for other persons who will be participating in the group ordering and an invoice for the amount due from the initiating customer. The amount due from the initiating customer could be an amount set by the initiator, or, alternatively, could be the amount of the item divided by the number of purchasers. The system would then generate messages, such as e-mails or text messages, to the list of contacts specified by the initiating customer. Each message contains a description of the item ordered, such as the catalog listing, a listing of the other persons in the group and their contact information, a listing of which other group members have agreed to the order, an indication of a recommended contribution amount, and a button or other means that allows the user to participate in the group order with a single operation (such as clicking the button). While the recommended contribution amount could be automatically determined or set by the initiator, each contributor could also input a separate amount indicating what they are willing to contribute to the group purchase.

FIG. 5a is a flowchart illustrating one process by which a shopper can modify a placed order. Generally, a shopper will receive an order confirmation via their preferred communications method. The order confirmation will contain a way for the user to modify or cancel their order. For example, an email could contain two HTML links; one to immediately cancel the order, and another to modify the order. If the user has chosen to modify or cancel the order, the process outlined below allows the modification.

In step 502, a request to modify an order is received. In step 504, a check is made to determine whether the order has been processed for shipping. If it has been processed for shipping, execution proceeds to step 506, where the shopper is informed that the order has already been processed. In step 508, the shopper is forwarded to a means to process a return. Returning to step 504, if the order has not yet processed for shipping, execution transitions to step 508, where a modification can be made. For example, the user can modify the quantity of the items ordered, the shipping address to where the order is to be shipped, the properties of the product, such as size, quantity, color, features, etc., or some other type of modification. In addition, the user can modify the order by applying a coupon, which may be in the form of a code that is entered. It should be noted that an order cancellation can be made by modifying the quantity ordered to zero. In step 512, the process is exited.

FIG. 5b is a flowchart depicting a process by which a return can be processed. In step 552 a request is received to return an item. In step 554, a return label is printed, and in step 556, instructions for the customer to return the item are printed. In step 558, a return record is created corresponding to the order with the status “return in process,” and in step 560, the process exits. The return will then be received and processed by a warehouse, and the customer's funds returned.

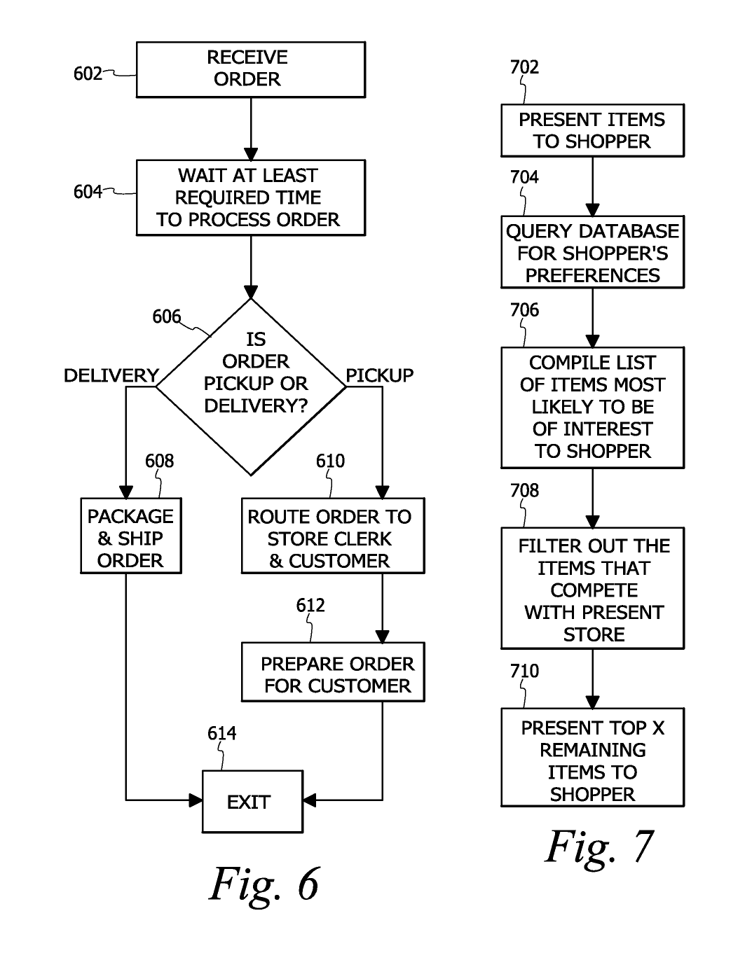

FIG. 6 is a flow chart depicting one process by which an order placed using the disclosed multi-tenant e-commerce system can be fulfilled. In step 602 an order is received by a shop. In step 604, a time period is marked off during which the shop is not permitted to process the order. This can be accomplished by not forwarding the order to the shop for the prescribed time, or, alternatively, through a business rule prohibiting the shop from changing the order status to “in process” for a prescribed period of time. This time period is required so that shoppers can make modifications or cancel an order shortly after ordering. In step 606, a determination is made as to whether the customer placed the order for delivery, or whether the customer intends to pick the order up. If the customer placed the order for delivery, in step 606 the order is packaged and shipped to the customer, and the process exits in step 614. However, if the customer placed the order for pickup, execution transitions to step 610 where the order is routed to the appropriate physical store closed to the customer's location. In step 612, the order is prepared for pickup by the customer by staff at the store, and the process exits in step 614. This process of order fulfillment allows customers to seamlessly cancel orders as well as to seamlessly return undesired goods.

An important feature of the disclosed multi-tenant e-commerce system is the function of presenting an item from a first shop to shoppers of a second non-competitive shop. This is generally accomplished by gathering a user's preferences, either directly from the shopper, or by monitoring the user's shopping habits. It should be noted that the disclosed e-commerce system encompasses both methods using any of the techniques known in the art.

FIG. 7 is a flow chart depicting one process by which items from one shop can be presented while a user is browsing a non-competitive shop. In step 702 items are presented to a shopper. In step 704, database 108 is queried for the shopper's preferences. Based on those preferences, a list of items most likely to be of interest to the shopper is compiled in step 706. In step 708, any items that would compete with offerings of the shop that the customer is presently browsing are filtered out. In step 710, the X items that are most likely to appeal to the customer are presented to the customer within the shop that s/he is browsing. Generally X should be a fairly small number, such as 1-3 items, although certain embodiments could present more items to a user.

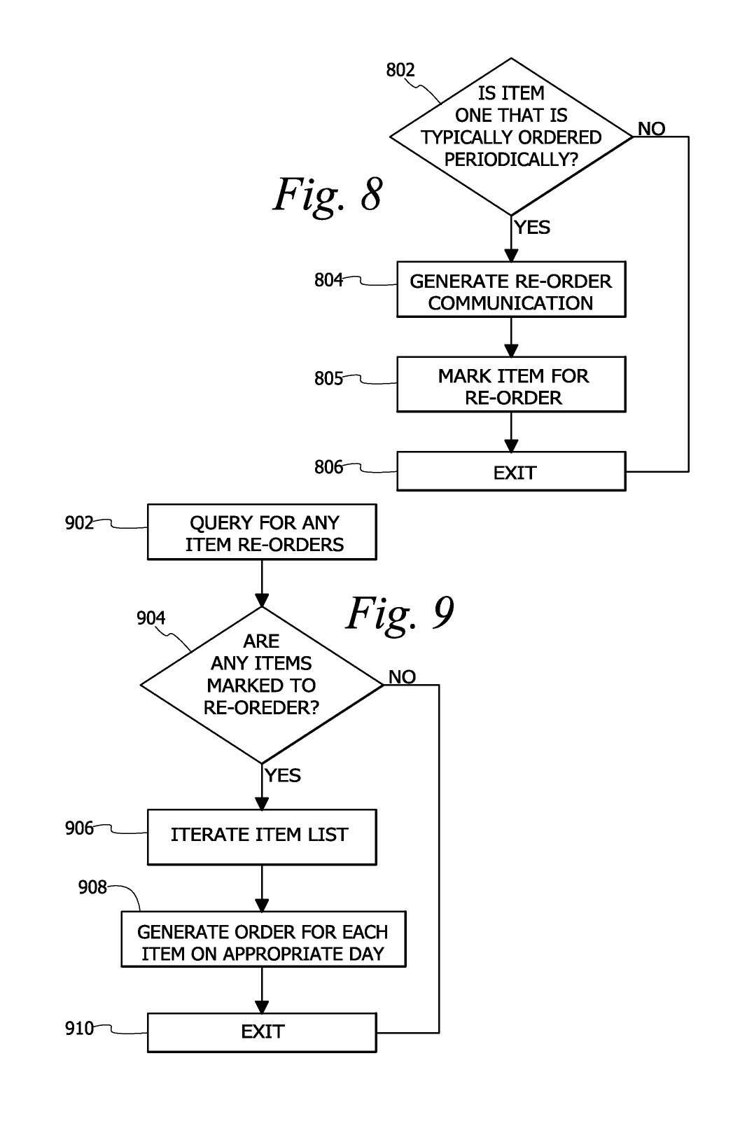

FIG. 8 depicts a flowchart describing one process by which certain items can be flagged for automatic reordering. In step 802, after an item is ordered a check is made to determine if it is one that is often ordered periodically. Items that are often ordered periodically include staple foods, such as rice, cleaning products, such as bleach, and personal care products, such as deodorant. In addition, other items may be flagged for reordering by a particular customer, or by the collective shopping patterns of all customers of the system. If the recently ordered item is not that is often ordered periodically, the process exits in step 806. However, if the recently ordered item is one that is often ordered periodically, execution transitions to step 804, where a communication to the shopper that ordered the item is generated and transmitted to the shopper, and in step 805, the item is marked for reordering on a standard schedule. The process then exits in step 806.

With regards to the communication generated in step 804, it can be for example, an email, a text message, or a robo-call, as indicated by the shopper's preferences (if a preference is set). In the communication, the user will be notified that a periodic order has been created, and given an option to modify the reorder period, or cancel it entirely. For example, an email can contain a hyperlink to a page allowing the user to set the reorder period or cancel the reorder entirely.

Turning to FIG. 9, a flowchart depicting one process by which periodic reorders can be automatically generated. The depicted process is to be run at a periodic interval, such as one time per day, and can be run for every shopper in the database. In step 902, a shopper's record is queried to determine if there are any item reorders. If there are not, the process exits in step 910. However, if there are item reorders, the list of reorder items is iterated in step 906, and, for each item reorder that should be ordered at the time the process is ran, a new order is generated and processed in step 908 as discussed earlier in this disclosure. The process then exits in step 910.

Another feature of one embodiment of the disclosed e-commerce solution is to allow lowest cost routing of orders by merchants (as well as by consumers as previously discussed). For example, it is well known that different payment processors charge different rates depending on various factors, such as the particular card that is presented. Accordingly, a merchant can configure the e-commerce system so that payments by, for example, Discover Card, are processed by a first processor, while American Express payments are processed by a second processor, and payments by Mastercard and Visa are processed by a third processor.

In addition, the system can periodically send communications, such as emails and SMS texts to shoppers that use the system. The communications can contain catalog listings of items that the shoppers are likely to be interested in based on the shopper's buying patterns, or that merchants are attempting to promote to certain classes of shoppers. In addition, the listings can contain indicia that allow the user to easily purchase the listed items. For example, an email or push notification can contain a button for each item listed in the communication; by pressing the button, the user can purchase the item with a single click as outlined herein. Similarly, an SMS communication can indicate a numeric code that the user replies with to purchase a particular item.

One issue that arises with conventional e-commerce solutions is that customers can abandon an order prior to completing it. This can lead to items being “orphaned” in the shopping cart. Items can be orphaned for a variety of reasons. First, the user can intentionally abandon the order. This would occur, for example, if the user did not want the items. Second, a user may experience a technical issue, such as a hardware or software crash, or a network issue, prior to completing the order. Or third, a user may have something more urgent arise, that distracts her attention from shopping prior to her completing the order. In cases two and three, both the user and the store are missing the benefit of completing the order.

In accordance with one embodiment, a communication, such as an email, SMS text, or push notification is generated and sent to a shopper after items are orphaned in a shopping cart for some period of time, such as, for example, four hours. The communication contains a listing of the items in the abandoned cart, and a “complete order” (or equivalent) device. By pressing the complete order (or equivalent) device, the order is completed, and the items in the cart are sent to the shopper.

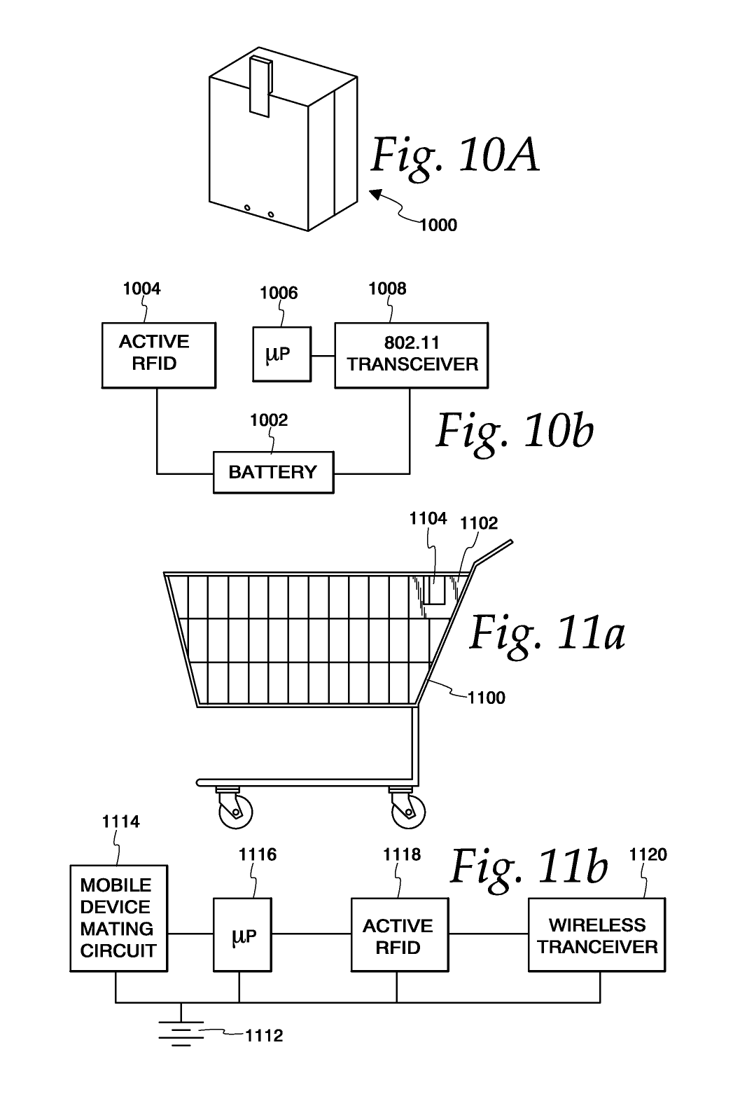

The disclosed e-commerce system also envisions improving on the traditional retail shopping experience by providing a novel new way to shop for goods. This embodiment is explained with reference to FIGS. 10a and 10b. In particular, the disclosed shopping system would allow customers of a retail store to purchase items simply by placing them in a specialized tote bag 1000. The tote bag 1000 contains a simple circuit woven into one of the interior walls or bottom comprising a battery, an active RFID device, and a wireless transceiver (such as an 802.11 transceiver). Each tote bag 1000 will need to be registered to a particular person who will need to have a preregistered payment means, such as a credit card or online wallet. To use this system, every item in the store must include a passive RFID, which, when brought in proximity to the active RFID of the tote bag 1000 signals a purchase by the tote bag's 1000 owner.

Turning to FIG. 10b, a simple block diagram of the tote bag circuit is disclosed. A battery 1002 powers an active RFID 1004. The active RFID 1004 can detect when a passive RFID coupled to a retail item (not shown) is brought into close proximity, such as when the item is placed in the tote. When this occurs, the active RFID 1004 signals the microprocessor 1006, which then causes the active RFID 1004 to read an identifier stored in the passive RFID corresponding to the item to which the passive RFID is attached. This identifier is then passed to the microprocessor 1006, which then uses the transceiver 1008 to transmit the item identifier to a store server (not shown) which completes the purchase on behalf of the user.

Given that the tote bag 1000 may come into contact with items that are within the store, but are not placed inside the tote bag 1000, there is a possibility that items could be spuriously purchased. One way to prevent this would be to shield the outside of the tote bag 1000 to prevent even a close coupling of the active RFID 1004 to a passive RFID (not shown) from activating the active RFID.

In another embodiment of the disclosed retail shopping service, consumers can utilize a mobile computing device to check out a shopping cart. Generally, consumers will register their mobile device with the shopping cart, which will operate similarly to the previously described tote bags 1000. Turning to FIGS. 11a and 11b, each shopping cart 1100 incorporates a circuit board 1102. In addition, in embodiments that are intended to mate with smart phones, a cradle 1104 can be provided.

The circuit 1102 can comprise a battery 1112, a mobile device mating circuit 1114, a microprocessor 1116, an active RFID, and a wireless transceiver 1120. The mobile device mating circuit 1114 can be a wired circuit, a wireless circuit, or both. For example, the mobile device mating circuit 1114 can be a wireless mating circuit, such as, for example, a Bluetooth wireless mating circuit. In such an embodiment, a customer would need to obtain an identifier (such as a number) from the shopping cart 1100, and input that into an application on the user's mobile computer device, which would then mate with the shopping cart 1100. The mobile device mating circuit 1114 can also be a wired circuit, such as, for example, a USB circuit. In such an embodiment, the user would physically mate a USB port on her device with a USB connector on the shopping cart 1100, which would activate an application on the user's mobile computing device allowing the user to confirm that the mating had occurred.

After the user's mobile computing device was mated with the mobile device mating circuit 1114, the microprocessor 1116 verifies that the user's mobile device contains a valid payment option. The active RFID 1118 and wireless transceiver operate similarly to the same devices in the tote bag embodiment.

In particular, in one embodiment, the active RFID 1118 can be mounted in a central position within the shopping cart 110. The active RFID 1118 detects when a passive RFID coupled to a retail item (not shown) is brought into close proximity; i.e., by the shopper moving it to within a few inches of the active RFID 1118. When this occurs, the active RFID 1118 signals the microprocessor 1116, which causes the active RFID 1118 to read an identifier stored in the passive RFID corresponding to the item to which the passive RFID is attached. This identifier is then passed to the microprocessor, which then uses the transceiver 1120 to transmit the item identifier to a store server (not shown) which completes the purchase.

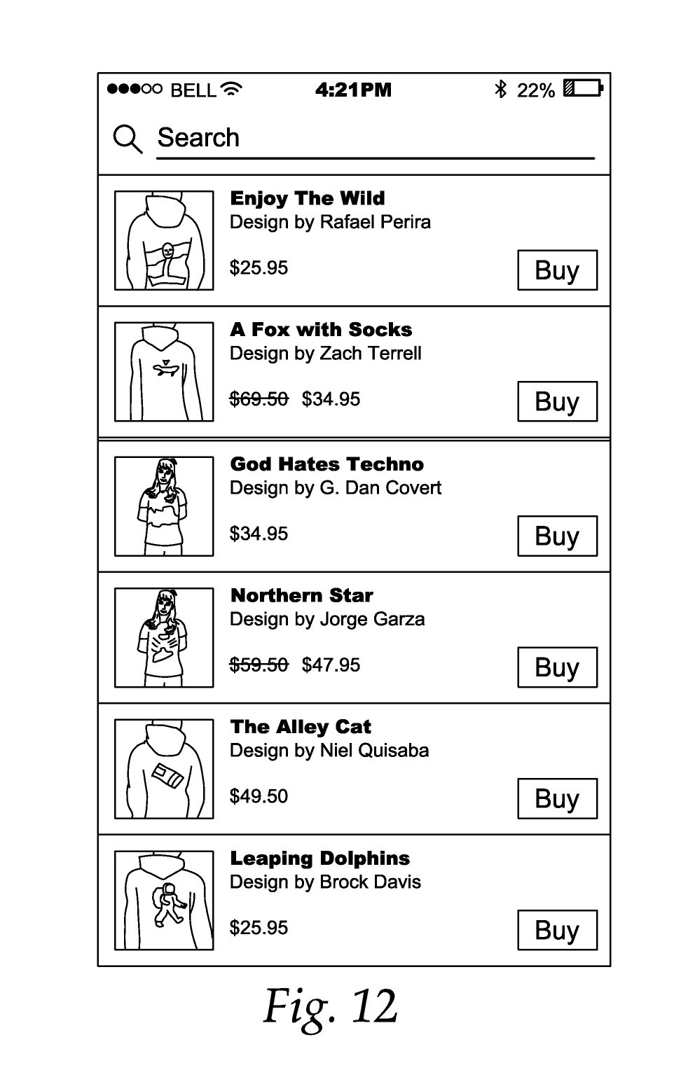

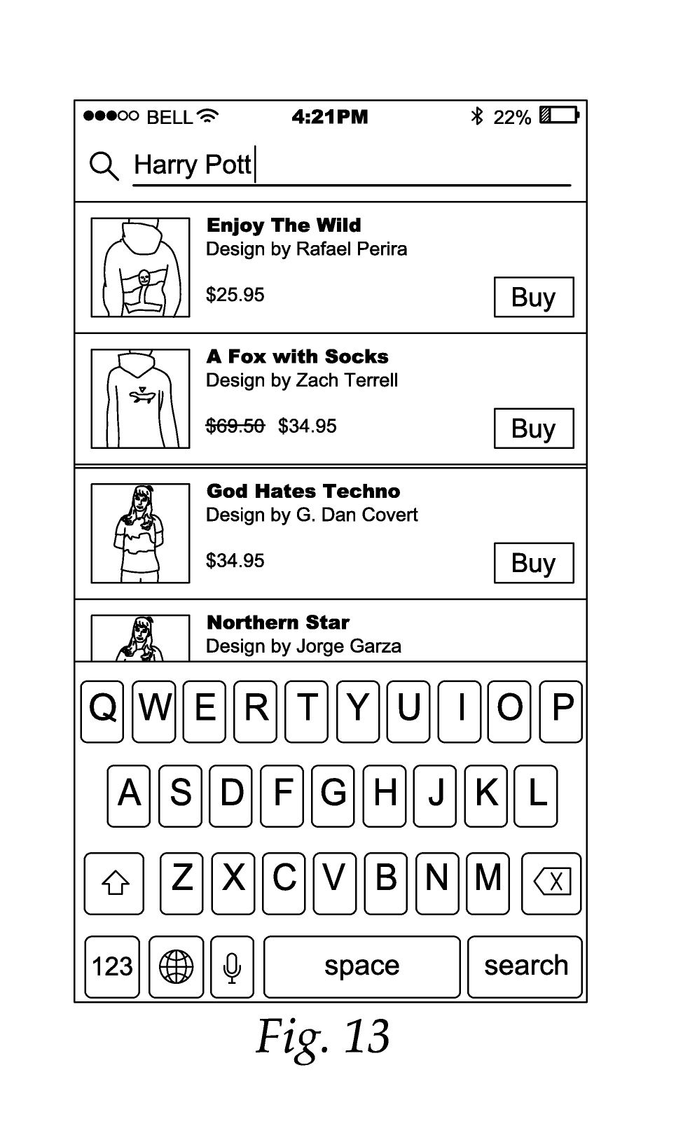

FIGS. 12 and 13 illustrate one embodiment of a smart phone application for use with the disclosed multi-tenant e-commerce system. Turning to FIG. 12, one embodiment of a view is depicted that a shopper that has already registered with the e-commerce system could see on first entering the application. The view depicted is customized to the shopper, and does not depict the listings on any particular store. Rather, based on the preferences of the user as determined by information submitted by the user or by monitoring the user's activities, products of many different shops can be displayed. FIG. 13 depicts a search by a shopper. In this embodiment, discovery of items is driven by the user's preferences and by searches conducted for specific items. As depicted, a standard soft keypad is used to enter a search term.

According to another embodiment, a user may receive electronic marketing communications from a seller and wish to purchase a highlighted product or service from the seller. For example, if a retailer sends an electronic communication (e.g., email, text, push notification) to a user who has previously registered to receive product information and/or marketing offers, the user typically cannot quickly and easily make the purchase from the electronic marketing communication. From the user's perspective, if the user is interested in purchasing a product that the user read about or saw in the electronic marketing communication, the user typically is required to go through multiple steps to buy the product. For example, the user may click on the desired product link in the electronic marketing communication, which may take the user to a product page providing more information on the product. Alternatively, after the user clicks on the desired product link in the electronic marketing communication, the product may be added to an electronic shopping cart on the retailer's website, after which the user then has to go through the entire checkout process.

From the retailer's perspective, the retailer may utilize data that they have collected on the user and provide marketing emails and notifications to surface or highlight products that the user would most likely be interested in purchasing. However, merely sending the user to a product page or adding the product to a shopping cart provides for a slow conversion of the user purchasing the product based on the electronic marketing communication. Also, even if the product is added to a shopping cart for the user based on the user clicking a link on the electronic marketing communication, the transaction may not be completed (e.g., the shopping cart is abandoned) because the user cannot quickly and directly buy from the electronic marketing communication. It is desirable to be able to provide a way for users to complete a purchase directly from an electronic marketing communication in a single step, for example as with a single click.

The disclosed subject technology describes systems and techniques for providing users a way to buy directly from an electronic marketing communication. For example, a user (e.g., consumer) may onboard or register with a retailer's website, providing user information such as the user's email address, the user's shipping address, the user's billing information (e.g., credit card information, billing address, etc.), etc. The user may merely register with the retailer for potential purchases in the future, or the user may onboard with the retailer's website as part of an initial shopping experience. During the registration, the user may select that the user wishes to receive marketing communications regarding the retailer's products or services, or such an agreement may be a default setting of the onboarding process.

As another example, a user may download or install an application on the user's mobile device (e.g., smartphone, tablet computer, etc.). If not previously registered, the user may onboard or register through the application (i.e., input the user's email address, the user's shipping address, the user's billing information, etc. into the application on the mobile device), and the application may then automatically register the user with the seller's system when the user's mobile device connects with the seller's system. Once registered, however, regardless of the method of registration, such information is saved and it is not necessary to input such information again. In yet another example, the user may be recognized by the seller's system or website upon connection. Here, the user may automatically login by entering the user's password.

Afterwards, the system may periodically send communications, such as emails, SMS texts, tweets, push notifications, etc., to shoppers that use the system. The communications may contain catalog listings of items that the shoppers are likely to be interested in based on the shopper's buying patterns, or that merchants are attempting to promote to certain classes of shoppers. In addition, the listings may contain indicia that allow the user to easily purchase the listed items. For example, an email or push notification may contain an electronic “buy” button or icon for each item listed in the communication. By selecting the “buy” button/icon, the user may purchase the item with a single click as outlined herein. Similarly, an SMS communication may indicate a numeric code that the user replies with to purchase a particular item.

The user may receive and open an electronic marketing communication, such as an email, text, tweet or push notification, however alternate electronic marketing communications may be used, from the retailer for a product or service that the user may be interested in purchasing. In the below example, which is purely for exemplar purposes, the electronic marketing communication is an email. The marketing email may include a unique or specific unified record locator (URL) that corresponds to the particular user and the particular product in the marketing email (e.g., existing user/product pair set). Further, the URL may be linked to a “Buy” button/icon or other aspect of the marketing email. If the user is logged into the retailer's system and desires to purchase the particular product in the marketing email, in one embodiment the user will select to buy the product directly from the email, such as by clicking on the “Buy” button or selector. When the user clicks or otherwise selects the “Buy” button/icon in the email having a specific URL, and if the user's requisite purchasing information is complete and present, the transaction is automatically processed and the product is purchased. In other words, all the user has to do is select one link, such as the “Buy” button/icon in the user specific marketing email that follows the specific URL, and the user purchases the product. After the user purchases the product, the purchase transaction follows the retailer's fulfillment process and the user receives the product.

In another example, if the user clicks on or otherwise selects the specific URL link in the marketing email, for example, the “Buy” button/icon in the email, but the user is not currently logged in to the retailer's system, the user may be prompted to enter the user's user name and password to log in, after which the purchase transaction will be completed if the requisite purchasing information is complete and present. Similarly, if the user is already logged in to the retailer's system when the user clicks or otherwise selects the specific URL link in the marketing email, but some of the required user purchasing information is not present in the retailer's system or network, the user may be prompted to enter the missing user information. The purchase may then be completed as soon as the missing user information is entered or gathered by the system. For example, the user may have registered with the retailer without wishing to save credit card information on the retailer's system, so the user will have to provide credit card information each time the user makes a purchase. Thus, in the example above, once the user clicks on or otherwise selects (e.g., keyboard selection, touchscreen selection, etc.) the specific URL, the user is prompted to enter the required credit card information and the purchase is completed. Further, it is understood that after all necessary information has been entered by the user, that information is saved and will not have to be reentered in the future, and thus future purchases can be made simply by selecting the “buy” button/icon and without having to reenter any additional information.

In another example, a user may have previously been on a sellers website and gone so far as to add items to a shopping cart, but then abandoned the shopping cart for any number of reasons (e.g., the user had to turn off the mobile device or the connection was lost, something more important came up, etc.). The seller may use the abandoned cart as a marketing opportunity, such as by offering a coupon via email for the user to return and complete the order. However, traditionally, to complete the order the user typically has to return to the site and complete the checkout process from the beginning.

Similar to the process discussed above, an electronic communication containing a URL that is specific to both the user and the abandoned cart product list may be sent to the user via email, text/SMS message, push notification (e.g., via a retargeted ad, etc.). Here, the user may simply click on or otherwise select the specific URL, such as a “Buy” button/icon having the specific URL, and provided the user is authenticated and the requisite purchasing information is present, the contents of the previously abandoned shopping cart may be automatically purchased. Again, if the user is logged in to the seller's system, including but not limited to its website or application, but some or all of the requisite purchasing information is not present, the user may be prompted for the missing information and the contents of the abandoned shopping cart may be purchased as soon as the missing purchasing information is provided or gathered. Similarly, if the user is not logged in the user may be prompted to log in and the purchase of the abandoned shopping cart may be completed as long as the requisite purchasing information is present.

For example, a user may go onto a seller's website and fill a shopping cart with items the user wants to purchase. However, the user may need to go to an important meeting or event before being able to complete the purchase, so the user abandons the shopping cart by turning off the mobile device or computer the user was ordering from. The user may then forget about the intended purchases or not be urgently compelled to return and complete the order. The seller may then send a follow up email suggesting that the user complete the transaction by simply clicking on a specific URL in the email. Here, the user never actually logged off of the system and assuming that the user's purchasing information (e.g., the user's email address, the user's shipping address and the user's billing information) is present, the user's click or selection of the specific URL, such as a “Buy” button/icon linked to the URL, will immediately complete the purchase transaction of the items in the abandoned shopping cart.

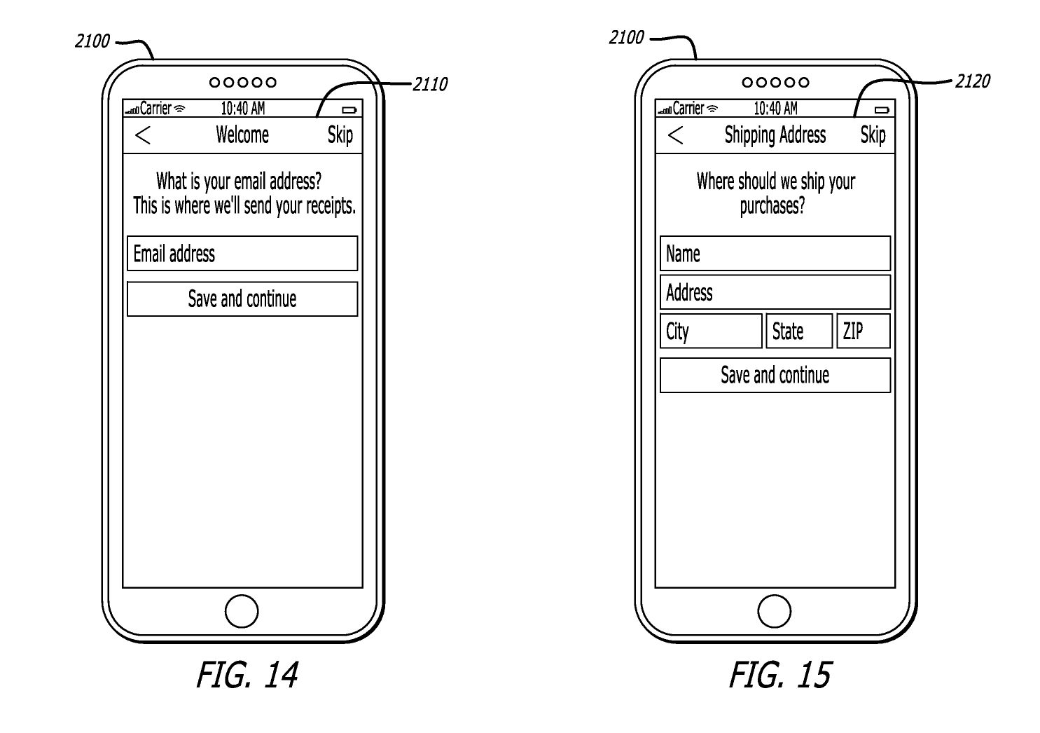

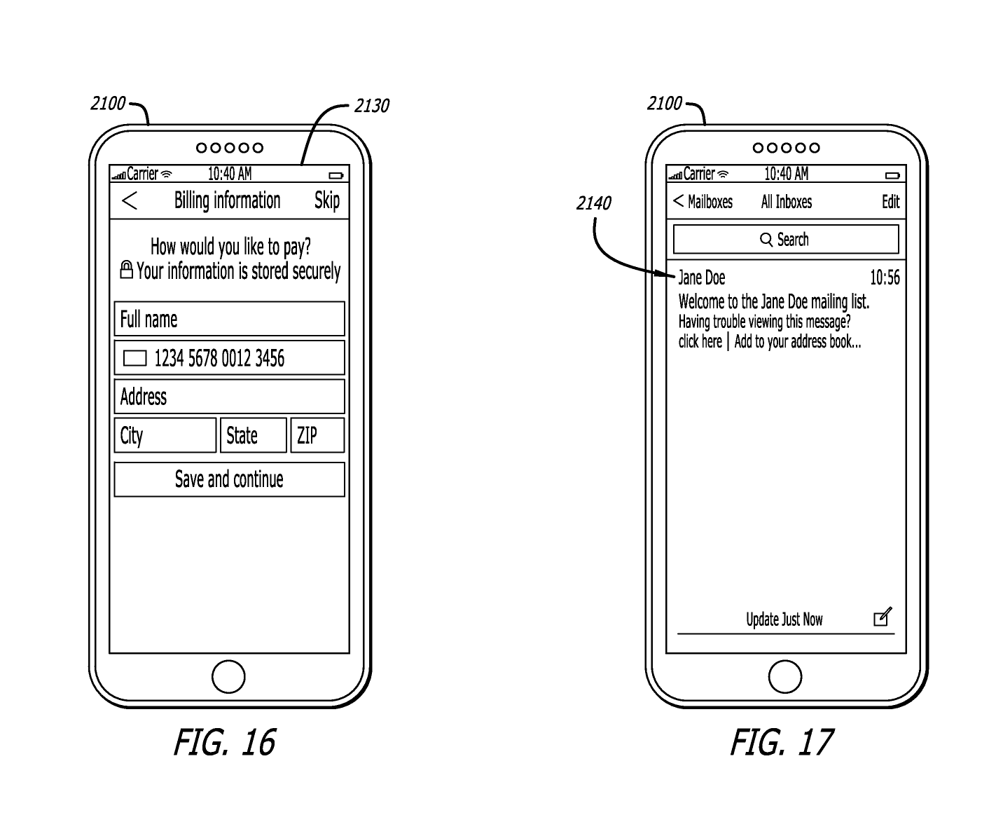

For example, as shown in FIGS. 14-16, a user may onboard or register with a seller's website using a mobile device 2100 (e.g., smartphone) in order to purchase products from the seller. In this example, the user is prompted by an email user interface 2110 to enter the user's email address as shown in FIG. 14. As shown in FIG. 15, the user is prompted by a shipping address user interface 2120 to enter the user's shipping address. Similarly, as shown in FIG. 16, the user is prompted by a billing information user interface 2130 to enter the user's billing information, such as payment information (e.g., credit card information or other electronic payment information) and the user's billing address. The user may provide some or all of the prompted information without intending to purchase any products or services at that time, or the user may provide the prompted information as part of an initial purchase process.

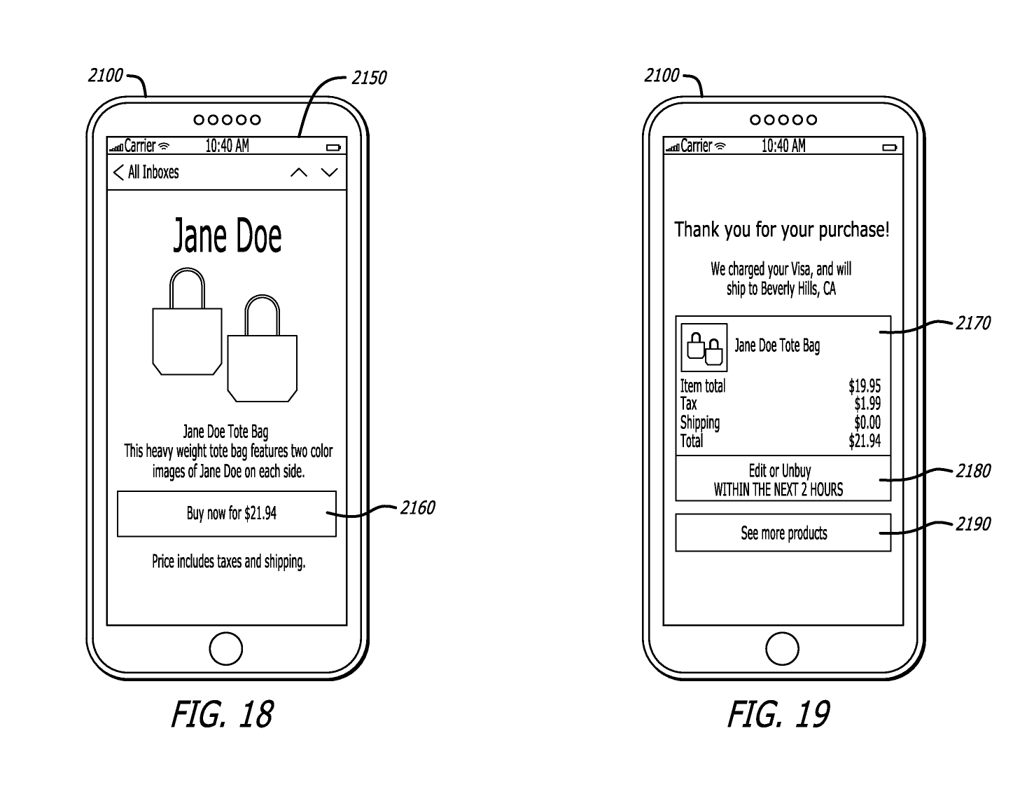

Once the user is known to the seller (e.g., partially or fully registered), the user may be targeted with an email 2140, as shown in FIG. 17. Opening the email 2140 provides an electronic marketing communication 2150 containing a specific link (e.g., URL) 2160 to buy a product at a particular price, as shown in FIG. 18. The price may be a total net price to the user that includes all taxes and shipping charges so that the user has no purchasing surprises regarding the final purchase, for example. The electronic marketing communication 2150 may include any other desired marketing information as well (e.g., product pictures, product name, and product description).

Here, the user may have previously shown an interest in the product (e.g., previous browsing history at seller's website, indication of product interest during registration, abandoned purchase of the product). Alternatively, the email 2140 may be a targeted marketing communication based on market research or demographics without any direct indication from the user as to interest in the product, for example.

If the user is logged in and the user's shipping/billing information is complete, selecting the link 2160 completes the purchase of the product associated with the link 2160. A receipt 2170 is then provided to the user, as shown in FIG. 19. The receipt screen or interface may also include a change selector 2180 (e.g., unbuy selector, edit selector) and a continue shopping selector 2190. For example, the completed purchase may be immediately cancelled after selecting or clicking on a change selector 2180 in the form of an unbuy selector or button. As another example, the completed purchase order may be modified after selecting or clicking on a change selector 2180, in the form of an edit selector or button, within the prescribed time allotted, which is two hours in this example. Here, order modifications may include changing or modifying the user's shipping address, the user's billing information, product options (e.g., size, color, material), product quantities, and the like. The order modification time may be preset by each seller. Once the modification time has elapsed, the order can no longer be edited or unbought through the link. The continue shopping selector 2190 may be a button or link that takes the user to the seller's website or loads another product page on the user's mobile device 2100.

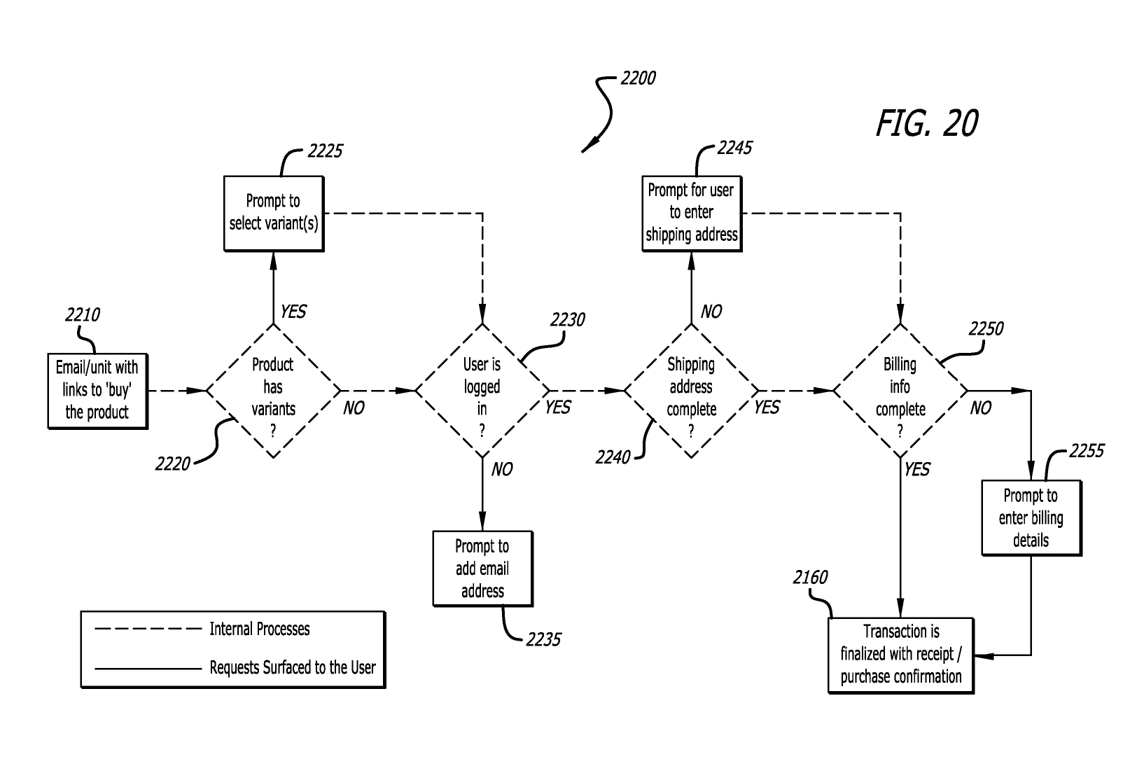

As shown in FIG. 20, in one embodiment, a direct from communication buying method 2200 begins in step 2210 when a user receives an electronic marketing communication with link(s) to buy one or more products. After the user clicks on or otherwise selects a link, such as by selecting the “Buy” button in the electronic marketing communication where the “Buy” button contains or is linked to a URL, the system or application may determine if additional information in necessary to complete the transaction, or if all information is complete and the transaction can be finalized. For example, the system may consider in step 2220 whether the suggested product has variants (e.g., size, color). If so, the user is prompted to select the desired variants in step 2225. The system or application also determines if the user is currently logged in in step 2230. If not, the user is prompted to input login information in step 2235, which may include, for example, the user's email address and/or password to become logged in to the seller's system or application.

As further shown in FIG. 20, the system or application also determines if the user's shipping address is complete in step 2240. If any or all of the shipping address is not complete, the user is prompted to provide the missing information in step 2245. Similarly, the system or application determines if the user's billing information is complete in step 2250, prompts the user to provide any missing billing information in step 2255. The system or application also determines if the user information entered by the user (i.e., billing address, billing credit card, etc.) is valid. At the point that the system or application determines that the user is logged in and the user's purchasing information is complete, the transaction for the purchase of the suggested product is completed in step 2160. For example, a receipt and/or purchase confirmation may be generated and provided to the user.

As outlined in FIG. 20, the purchase of the suggested product may be achieved and completed by simply clicking on a link, e.g., the “Buy” button. In such case, the product has no variants, the user is already logged in to the seller's system or application, and the user's purchasing information (e.g., shipping address and billing information) is already complete. Thus, the only interaction required from the user is to read the targeted email and click on or otherwise select the link to buy the highlighted product. Each part of the process that is missing or incomplete then involves an additional request to be surfaced to the user.

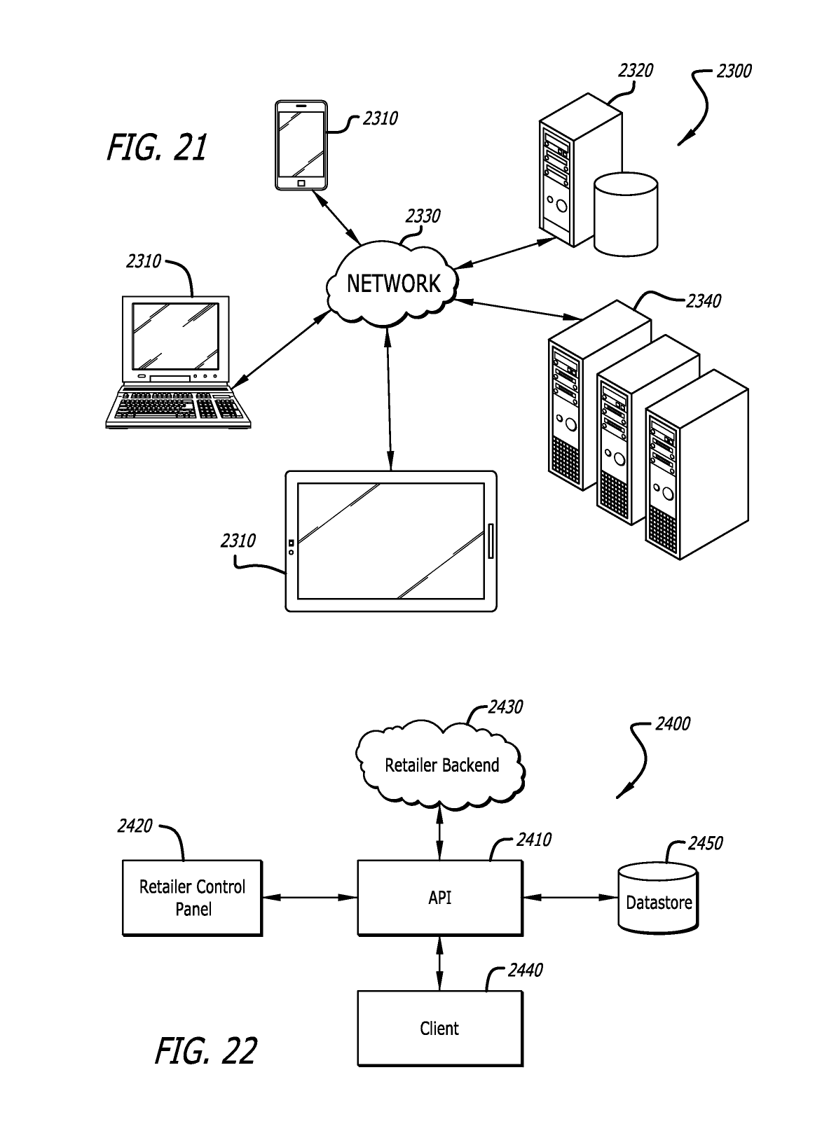

As shown in FIG. 21, the direct from communication buying application may be provided on a client-server system 2300. For example, the direct from communication buying application may be provided on a user's electronic device 2310 (e.g., smartphone, tablet, phablet), where the direct from communication buying application connects to sales websites or online stores through the server 2320 of a seller or retailer over a network 2330 (e.g., the internet). A separate server based website 2340 may also be provided. The separate server based website may be configured to provide the same direct from communication buying application features to registered users as the device based direct from communication buying application. For example, a direct from communication buying application user may log in directly to the direct from communication buying application website from any device and complete a purchase transaction. This allows the user to access the direct from communication buying application if the user's main device is not functioning, such as if the user's smartphone battery died, for example.

As shown in FIG. 22, the direct from communication buying application 2400 may be an application program interface (API) 2410 provided on a user's electronic device (e.g., smartphone, tablet, phablet) that interacts with one or more systems involved in an electronic or online purchase transaction. For example, the API 2410 may interface with a retailer system through a Retailer Control Panel 2420 and through a Retailer backend system 2430. The API 2410 may also interface with the user through a Client device and/or application 2440. The API 2410 may further interface with one or more databases 2450, such as a Datastore database that may provide information regarding abandoned and/or completed transactions.

In various embodiments, as explained above, the system allows for unbuying and/or modifying previously processed orders. Additionally, the system may also allow in certain embodiments for various promotions or benefits to the user post processing, including, but not limited to, the batching of certain orders for shipping, and promotions based on spend thresholds.

In one embodiment, immediately upon the user selecting to “buy” a product, the system processes the order. Once the order is processed, in one embodiment an electronic receipt or confirmation is provided to the user, signifying that the order is completed, and the system locks the order. Additionally, at that time the system may create one or more different thresholds, including but not limited to an (1) edit time value, a (2) batch duration time, which is also referred to as the order cutoff time; and (3) free shipping qualification based on certain thresholds. In one embodiment, the edit time value is a period of time set by the retailer/seller within which the user may modify or unbuy their order following the completion of the order. Typically, the edit time is configured by the retailer/seller as part of their system configuration. For example, if the seller sets the edit time at 2 hours, when a buyer makes a purchase at 4:15, the buyer has until 6:15 to either unbuy or modify that order. After 6:15, in this example, the order is marked as unchangeable and the buyer/user can no longer make changes through the system to that order.

Similarly, in one embodiment, a batch relates to orders that are designated to be shipped to the same address and which are placed within a certain window of time, or before a certain deadline, both of which are defined by the seller/retailer, so that they can be passed to fulfillment together. Doing so helps the user/buyer not have to repeatedly pay separate shipping for items purchased within a buying session, and it also allows for logistical efficiencies for the retailer. Like the edit time value, the batch duration time is a period of time set by the retailer/seller within which all orders by a user that are designated to be shipped to the same address can be shipped together. Alternately, the batch duration time may be a deadline whereby all orders by a user that are designated to be shipped to the same address can be shipped together. For example, if the batch duration time is set at 3 hours, and the buyer makes a purchase at 4:15, all subsequent orders of the buyer that are designated to be shipped to the same address and which are completed prior to 7:15 will be batched together and the buyer will typically receive a reduced shipping rate for all batched purchases. As an alternate example, the seller/retailer may set a given time of day, such as 5:00 pm, as a batch deadline, whereby all orders made from the prior day at 5:01 pm until the present day at 5:00 pm, and which are designated to be shipped to the same address, will be batched together for shipment purposes. In such an embodiment, the batch would contain all completed purchases for the same address into a shipment so that it can be passed to the fulfillment system for processing at the same time every day, which in this example is 5:00 pm. Once a user buys an item, the system reminds the buyer about the time they have left to add to their order for reduced or no additional shipping cost.

Further, in one embodiment the system allows the retailer/seller to offer free shipping to the user based on certain requirements, such as attaining a threshold for dollars spent or items purchased in a session. For example, in one embodiment, the system will prompt the user after their make their first purchase about the additional money they need to spend, i.e. the ‘spend threshold’, within a time threshold determined by the retailer, to qualify for free shipping. Once the user hits the spend threshold within the time threshold, the shipping costs the user was charged when purchasing their prior item(s) will be reversed. Similarly, once a user buys an item, the system reminds the buyer about the time they have left to add to their order for reduced or no additional shipping cost.

In various embodiments, the system provides indicators on the various displays viewed by the user, e.g., website pages or application screens, of the time needed to qualify additional purchases for reduced shipping, the time/amount needed to qualify additional or all purchases for free shipping, or the time allowed and/or remaining for unbuying or editing an order.

Below are two examples of buying scenarios under the disclosed system:

### Example 1

Retailer threshold configuration: Edit time is 2 hours, free shipping qualification is $50, and batch duration time is 3 hours.

Buyer X logs into the system, an application on her smartphone, to make purchases. At 2:45 pm, Buyer X views Wrinkle Cream and is shown a price of $29.99, which is inclusive of shipping and tax. Buyer X selects “buy.” The system knows: (1) Buyer X has 2 hours to change anything about this order, (2) if Buyer X spends $50 total in over two hours she will qualify for free shipping, and (3) anything Buyer X orders in the next 3 hours could go in the same box, and she can receive reduced shipping costs.

At 2:47 pm, after her first purchase, Buyer X views a new product list. The footer on the screen states “spend $20.01 more by 5:45 to get free shipping on your Wrinkle Cream.” As identified, the system will calculate the difference in spend that will allow the user to earn free shipping.

At 2:53 pm, Buyer X buys an Insulated Family Cooler in Cali Stripes. Buyer X is charged the price of the item as well as tax. Buyer X is NOT charged for shipping because she has hit the threshold for $50 within the two hour window.

At 3:43 pm, Buyer X changes her mind about the Insulated Family Cooler and modifies it to the Emma Pink version since she is within the 2 hour edit time window.

At 4:45 pm, the initial order is marked as unchangeable and batching countdown starts. At 4:53 pm, the second order is marked as unchangeable and another batching countdown starts. Buyer X then sets her smartphone down for a while.

At 5:40 pm, Buyer X turns her smartphone back on and gets back into the application. The footer on the home view states “FREE SHIPPING ON ALL ORDERS PLACED UNTIL 5:45 pm.” At 5:44 pm, Buyer X buys Bug Spray. Buyer X is charged the price of the item as well as tax. Buyer X is NOT charged for shipping because she is still inside of the batching window of her first purchase.

At 5:46 pm, Buyer X views the ‘home’ product list on the application. All prices are now inclusive of the cost of shipping and the footer now shows “PRICES INCLUDE TAXES AND SHIPPING”. At 5:47 pm, Buyer X buys a Wine Glass, and is charged the price of the item as well as the price of shipping and tax. The system knows: (1) Buyer X has 2 hours to change anything about this order, (2) if she spends $50 total in over two hours, she will qualify for free shipping, (3) anything she orders in the next 3 hours could go in the same box, and we can save the user on shipping costs.

At 7:44 pm, the third order is marked as unchangeable and another batching countdown starts.

At 7:45 pm, the first order batching countdown ends. The system checks for all of the orders that are unchangeable that could be batched together; it finds the first, second and third orders and puts them together into a shipment. That shipment is sent to the identified shipping address. The process will also invalidate the countdowns associated with any of the items in the shipment.

### Example 2

Retailer threshold configuration: Edit time to 2 hours, and order cutoff time is 5 pm.

Buyer X logs into the system, an application on her smartphone, to make purchases. At 2:45 pm, Buyer X views Wrinkle Cream and is shown a price of $29.99, which is inclusive of shipping and tax. Buyer X selects “buy.” The system knows: (1) Buyer X has 2 hours to change anything about this order, (2) anything Buyer X orders until 5 pm could go in the same box, and she can save shipping costs.

At 2:47 pm, after her first purchase, Buyer X views a new product list. The footer on the screen states “REDUCED SHIPPING COSTS ON ALL ORDERS PLACED UNTIL 5:00 pm.”

At 2:53 pm, Buyer X buys an Insulated Family Cooler in Cali Stripes. Buyer X is charged the price of the item, tax, as well as the incremental cost of shipping. She is ONLY charged for the incremental cost of shipping because she has made the second order before the batching cutoff time (5 pm) of the day.

At 3:43 pm, Buyer X changes her mind about the Insulated Family Cooler and modifies it to the Emma Pink version since she is within the 2 hour edit time window.

At 4:45 pm, the initial order is marked as unchangeable and batching countdown starts. At 4:53 pm, the second order is marked as unchangeable and another batching countdown starts. Buyer X then sets her smartphone down for a while.

At 4:56 pm, Buyer X turns her smartphone back on and gets back into the application. The footer on the home view states “REDUCED SHIPPING COSTS ON ALL ORDERS PLACED UNTIL 5:00 pm.” At 4:57 pm, Buyer X buys Bug Spray. Buyer X is charged the price of the item, tax, as well as the incremental cost of shipping. She is ONLY charged for the incremental cost of shipping because she is before the batching cutoff time (5 pm) of the day.

At 5:06 pm, Buyer X views the ‘home’ product list on the application. All of the prices are now inclusive of the cost of shipping, the footer now shows “PRICES INCLUDE TAXES AND SHIPPING”. At 5:47 pm, Buyer X buys a Wine Glass, and is charged the price of the item as well as the price of shipping and tax. The system knows: (1) Buyer X has 2 hours to change anything about this order, (2) anything she orders in the next ˜23 hours (until 5 pm the following day) could go in the same box, and we can save the user on shipping costs.

At 6:56 pm, the third order is marked as unchangeable.

At 7:00 pm, the daily order batching cutoff occurs. This occurs a full edit time after the configured order cutoff time. The system checks for all of the orders that are unchangeable that could be batched together; it finds the first three orders and puts them into a shipment. That shipment is sent to fulfillment.

At 7:47 pm, the fourth order is marked as unchangeable.

At 7:00 pm (next day), order batching cutoff occurs. The system checks for all of the orders that are unchangeable that could be batched together; it finds the forth order only, and puts it into a shipment. That shipment is sent to fulfillment.

Days later Buyer X receives two shipments, staggered by a day. The first containing her first three orders, the second (which arrive a day later) containing her fourth.

As used in this specification and any claims of this application, the terms “computer,” “server,” “processor,” and “memory” all refer to electronic or other technological devices. These terms exclude people or groups of people. For the purposes of the specification, the terms display or displaying means displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other transient signals.

To provide for interaction with a user, implementations of the subject technology described in this specification can be implemented on a computer system having a display device, e.g., a CRT (cathode ray tube), LCD (liquid crystal display), LED (light emitting diode), or DLP (digital light processing) monitor, for displaying information to the user and a keyboard and a pointing device, e.g., a mouse, a trackball, or a touchpad, by which the user can provide input to the computer system. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Aspects of the subject technology described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject technology described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the aspects described above should not be understood as requiring such separation in all aspects, and it should be understood that the described program components and systems can generally be integrated together in a single system device or multiple devices.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology. Features described under one heading or one subheading of the subject disclosure may be combined, in various embodiments, with features described under other headings or subheadings. Further it is not necessarily the case that all features under a single heading or a single subheading are used together in embodiments.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A direct from communication buying system, comprising:
one or more processors;
one or more storage memories;
a display; and,
a direct from communication buying module comprising instructions for causing the one or more processors to execute a method for providing a purchase directly from an electronic communication, the method comprising:
receiving, by a user, an electronic marketing communication from a seller;
providing, on the display, the electronic marketing communication comprising a listing of one or more products offered for purchase from the seller;
providing, on the display, a buy selector associated with at least one of the listed products;
determining, by the one or more processors, if the user is logged in to the direct from communication buying system;
determining, by the one or more processors, if user shipping address information is complete;
determining, by the one or more processors, if user billing information is complete; and,
providing, by the one or more processors, for completing an immediate electronic purchase transaction of the at least one of the listed products when the associated buy selector is selected, if it is determined that the user is logged in, the user shipping address information is complete and the user billing information is complete.

2. The system of claim 1, further comprising providing, on the display, a price associated with each of the one or more listed products.

3. The system of claim 2, further comprising providing, on the display, an indication that the price is the net price to the user, wherein the price includes all taxes and shipping charges.

4. The system of claim 1, further comprising providing, on the display, a receipt interface showing the completed electronic purchase transaction.

5. The system of claim 4, further comprising:
providing, on the display, an unbuy selector on the receipt interface; and,
providing for an immediate cancellation of the completed electronic purchase transaction upon selection of the unbuy selector.

6. The system of claim 5, further comprising providing, on the display, a time, preset by the seller, identifying how long the user has to unbuy the product.

7. The system of claim 1, further comprising:
providing, on the display, a product option user interface e, the product option user interface comprising one or more product option selection selectors; and,
providing for modification of the electronic purchase transaction before the electronic purchase transaction is completed when one or more of the product option selection selectors are selected.

8. The system of claim 4, further comprising;
providing, on the display, a change selector on the receipt interface;
providing, on the display, when the change selector is selected, an option user interface comprising at least one of a product modification selection selector, a shipping modification selection selector, and a billing modification selection selector; and,
providing for modification of the completed electronic purchase transaction when one or more of the product modification selection selector, shipping modification selection selector and billing modification selection selector is selected.

9. The system of claim 4, further comprising:
providing, on the display, a continue shopping selector on the receipt interface; and,
providing, on the display, an electronic shopping page upon selection of the continue shopping selector.

10. The system of claim 1, further comprising;
providing, on the display, a log in user interface if the user is determined not to be logged in to the direct from communication buying system, the log in user interface prompting the user to enter user log in information; and,
providing for completing the electronic purchase transaction when the user log in information is entered.

11. The system of claim 1, further comprising;
providing, on the display, a shipping address user interface if the user's shipping address information is determined not to be complete, the shipping address user interface prompting the user to enter missing user shipping address information; and,
providing for completing the electronic purchase transaction when the missing user shipping address information is entered.

12. The system of claim 1, further comprising;
providing, on the display, a billing information user interface if the user's billing information is determined not to be complete, the billing information user interface prompting the user to enter missing user billing information; and,
providing for completing the electronic purchase transaction when the missing user billing information is entered.

13. The system of claim 1, wherein the listing of one or more products is based on an abandoned shopping cart from a previous online interaction by the user with the seller, and, wherein the completed electronic purchase transaction comprises the purchase of products in the abandoned shopping cart.

14. A non-transitory machine-readable storage medium comprising machine readable instructions for causing a processor to execute a method for providing a purchase directly from an electronic communication, the method comprising:
providing, on a display, an electronic marketing communication comprising a listing of one or more products offered for purchase from a seller;
providing, on the display, a purchase price for each of the one or more listed products;
providing, on the display, a buy selector associated with each of the one or more listed products;
determining, by the one or more processors, if the user is logged in to the direct from communication buying system;
determining, by the one or more processors, if shipping and billing information is complete for the user; and,
providing, by the one or more processors, for immediately completing an electronic purchase transaction of one of the one or more listed products when the associated buy selector is selected, if it is determined that the user is logged in and the user's shipping and billing information is complete.

15. The non-transitory machine-readable storage medium of claim 14, further comprising machine readable instructions for:
providing, on the display, a receipt showing the completed electronic purchase transaction;
providing, on the display, a change selector;
providing, on the display, a time, preset by the seller, identifying how long the user has to make changes to the completed purchase transaction;
providing for a modification of the completed electronic purchase transaction upon selection of the change selector if the change selector is selected within the preset time;
providing, on the display, a continue shopping selector; and,
providing, on the display, an electronic shopping page upon selection of the continue shopping selector.

16. The non-transitory machine-readable storage medium of claim 15, wherein the change selector is an unbuy selector, and further comprising machine readable instructions for providing for an immediate cancellation of the completed electronic purchase transaction upon selection of the unbuy selector if the unbuy selector is selected within the preset time.

17. The non-transitory machine-readable storage medium of claim 15, further comprising machine readable instructions for providing for a modification of one or more of the user shipping address information, the user billing information, and one or more product option of the one or more purchased products upon the selection of the change selector.

18. The non-transitory machine-readable storage medium of claim 14, further comprising machine readable instructions for:
providing, on the display, a log in user interface if the user is determined not to be logged in to the direct from communication buying system, the log in user interface prompting the user to enter user log in information;
providing for completing the electronic purchase transaction when the user log in information is entered;
providing, on the display, a shipping address user interface if the user's shipping address information is determined not to be complete, the shipping address user interface prompting the user to enter missing user shipping address information;
providing for completing the electronic purchase transaction when the missing user shipping address information is entered;
providing, on the display, a billing information user interface if the user's billing information is determined not to be complete, the billing information user interface prompting the user to enter missing user billing information; and,
providing for completing the electronic purchase transaction when the missing user billing information is entered.

19. A direct from communication buying system comprising:
one or more processors;
one or more storage memories;
a display; and,
a direct from communication buying module comprising instructions for causing the one or more processors to execute a method for providing a completed purchase transaction from an electronic marketing communication, the method comprising:
providing, on the display, an electronic marketing communication from a seller comprising a listing of product information for a product offered for sale by the seller;
providing, on the display, a buy selector associated with the product;
determining, by the one or more processors, if the user is logged in to the direct from communication buying system;
determining, by the one or more processors, if user information is complete;
if it is determined that the user is logged in and the user information is complete, providing, by the one or more processors, for immediately completing an electronic purchase transaction of the listed product when the associated buy selector is selected without requiring further user interaction or a shopping cart checkout process;
providing, on the display, a receipt showing details of the completed electronic purchase transaction;
providing, on the display showing the receipt, a change selector;
providing, on the display showing the receipt, a time, preset by the seller, identifying how long the user has to make changes to the completed purchase transaction; and,
providing for a modification of the completed electronic purchase transaction upon selection of the change selector if the change selector is selected within the preset time.

20. The direct from communication buying system of claim 19, further comprising providing, on the display, if it is determined that the user is not logged in, a log in user interface, the log in user interface prompting the user to enter user log in information, and, if it is determined that the user information is not complete, providing, on the display, a user information user interface, the user information user interface prompting the user to enter missing user shipping address and user billing information, and providing for completing the electronic purchase transaction when the user log in information and any missing user shipping address and user billing information is entered.
